(19) United States
(12) Patent Application Publication
(10) Pub. No.: US 2024/0122387 A1
(43) Pub. Date: Apr. 18, 2024

(54) Composition Of A Thin-Wall Extruded Device And A Method Of Producing The Thin-Wall Extruded Device

(71) Applicant: PlantSwitch, Inc., Dallas, TX (US)

(72) Inventors: Robert E. Jerman, Chalfont, PA (US); Dillon Ray Baxter, Dallas, TX (US)

(21) Appl. No.: 18/486,638

(22) Filed: Oct. 13, 2023

Related U.S. Application Data
(60) Provisional application No. 63/416,145, filed on Oct. 14, 2022.

(51) Int. Cl. A47G 21/18; B29C 48/00

(52) U.S. Cl. CPC A47G 21/18; B29C 48/022; B29L 2023/008

(57) ABSTRACT

A composition including a biodegradable resin; a plant-based filler present in an amount of about 20 percent or more based on a total weight of the composition; one or more compatibilizers; and a plasticizer, a lubricant, or both; wherein the composition is configured to be extruded so that the composition forms a wall having a thickness from about 0.1 mm to 0.22 mm.

### CROSS-REFERENCE TO RELATED APPLICATION(S)

This application claims priority to U.S. Provisional Patent Application No. 63/416,145, filed on Oct. 14, 2022, the contents of which is hereby incorporated by reference in its entirety.

### FIELD

The present teachings provide one or more formulations or compositions and a method specifically tailored to create a thin-walled extruded device (such as a drinking straw).

### BACKGROUND

Currently, in some utensil applications, attempts are being made to move away from petroleum-based carbon sources and use renewable carbon sources. These renewable carbon sources may cost more than traditional petroleum-based carbon sources and/or have different strength characteristics than the petroleum-based carbon sources. In an attempt, to make an entirely biodegradable composition plant-based particles or plant-based fibers may be incorporated into the composition. However, the use of plant-based items such as hemp has generated challenges when used in a high percentage (e.g., above 20 percent), a thin-walled extruded device, or both. Due to the thinness of the walls the particles or fibers may extend through the wall causing weak walls or even failures in the walls. The present teachings seek to provide a thin-wall reinforced article where a high percentage of filler or fibers are present. What is needed is a composition and/or process where the fibers and/or fillers are maintained entirely within an interior of a thin-walled extruded device. It would be desirable to have a thin-walled extruded device where fibers and/or fillers are randomly distributed within the device.

### SUMMARY

The present teachings provide a formulation and method of forming a thin-walled extruded device. The formulation may include hemp. The formulation may include hurd of hemp. The formulation may include hemp in an amount of about 20 percent or more, 30 percent or more, or 40 percent or more of a total weight of the formulation. The formulation may include hemp fiber reduced to the predetermined particle combined together with hemp hurd or used in isolation in an amount of about 20 size and percent or more, 30 percent or more, or 40 percent or more of a total weight of the formulation. The present teachings seek to provide a thin-wall reinforced article where a high percentage of filler and/or fibers are present. The present teachings provide a composition or process where the fibers and/or fillers are maintained entirely within an interior of a thin-walled extruded device. The present teachings provide a thin-walled extruded device where fibers and/or fillers are randomly distributed within the wall of the device and preferably with a filler-free boundary layer on both the inner and outer wall.

The present teachings provide: a composition including a biodegradable polymer (e.g., resin); a plant-based filler present in an amount of about 20 percent or more based on a total weight of the composition; one or more compatibilizers; and a plasticizer, a lubricant, or both; wherein the composition is configured to be extruded so that the composition forms a wall having a thickness from about 0.1 mm to 0.22 mm.

The present teachings provide: a device including: a wall having a thickness from about 0.1 mm to about 0.22 mm; a biodegradable polymer; a plant-based filler; one or more compatibilizers; and a plasticizer, a lubricant, or both; wherein the plant-based filler is present in an amount from about 20 percent to about 40 percent by weight of the device.

### BRIEF DESCRIPTION OF THE DRAWINGS

FIG. 1 is a cross-sectional view of a utensil with particles evenly distributed within the utensil.

FIG. 2 is a cross-sectional view of a utensil with boundary layers and particles evenly distributed between the boundary layers.

### DETAILED DESCRIPTION

The present teachings provide a composition (formulation) and method to produce thin-walled extruded devices and articles (hereinafter devices). These devices may be thin to reduce an amount of material needed, but sufficiently thick to prevent the walls from failing during use. The devices may ultimately be biodegradable. The devices may biodegrade over a time of about 4 weeks or more, 6 weeks or more, 3 months or more, or 6 months or more. The devices may biodegrade over a time of about 1 year or less, 10 months or less, or 8 months or less, or about 6 months or less. The devices may biodegrade when subjected to water (e.g., after use). The device may have a length and a cross-sectional length (e.g., a diameter). The length may have a tensile strength. The length may have a flexural strength. The cross-sectional length may have a burst strength, a tensile strength, a flexural strength, or a combination thereof. The device may have sufficient strength so that when the device is used the device may maintain its shape and size.

The device may be a utensil. The device may be a straw. The device may have one or more exterior surfaces. For example, the device (e.g., utensil) may have an interior surface and an exterior surface. If the utensil is a straw the straw has an inner surface and an outer surface, with an area between the inner surface and the exterior surface. The filler particles may extend all of the way to the exterior surfaces. The filler particles may extend to only one of the exterior surfaces. If the filler particles extend to an exterior surface the filler particles may be free of extending out of the exterior surface. The filler particles may be only located within an interior surface of the device. For example, a boundary layer may be located between the inner surface (which includes the filler particles) and the exterior surfaces.

The boundary layer may be a layer that is substantially free of filler particles. The boundary layer may be a layer that isolates the filler particles from the exterior surface. The composition taught herein may allow the filler particles to flow within the device during manufacture so that the filler particles are located within the inner surface. The inner surface may be bounded by one or more boundary layers. If the device has one exterior surface then the boundary layer may be located between that exterior surface and the inner surface. The device may have two exterior surfaces or walls (e.g., an inner wall/surface and outer wall/surface) and each may be adjacent or directly located between the corresponding wall/surface and the inner surface. Substantially all of the plant-based filler may be located within the middle of the wall. The wall may be about 70 percent or more, 80 percent or more, 90 percent or more, 95 percent or more, and about 100 percent or less of the plant-based filler located within the middle of the wall. The device may include an outer wall then an outer boundary layer, an inner surface, then an inner boundary layer and an inner wall. The boundary layers may have a thickness of about 0.001 mm or more, about 0.005 mm or more, about 0.01 mm or more, about 0.05 mm or more, or about 0.1 mm or more (e.g., ±0.0005). The boundary layer may have a thickness of about 0.15 mm or less, about 0.1 mm or less, about 0.8 mm or less, about 0.6 mm or less, about 0.4 mm or less, about 0.2 mm or less, or about 0.15 mm or less. The boundary layers may all be substantially a same size. If more than one boundary layers are present then the boundary layers may have different sizes (e.g., thicknesses). The boundary layers may be sufficiently thick to form a shell or layer between an exterior of the device and filler particles. A strength of the device may depend on the composition of the device.

The composition may comprise a biodegradable polymer, a filler, a compatibilizer, a lubricant, or a combination thereof. The biodegradable polymer may be any biodegradable polymer that has sufficient strength to prevent failure for a predetermined amount of time (e.g., 4 weeks to 6 months), but sufficient biodegradability to break down after a predetermined period of time (e.g., 4 weeks to 6 months). The biodegradable polymer may be selected based on an intended application of a device. The biodegradable polymers may include ester bonds, amide bonds, ether bonds, or a combination thereof. The biodegradable polymers may be made of or include polyhydroxyalkanoates, polyhydroxybutyrate, phosphate buffered saline, polylactic acid, chitosan-based polymers, polysaccharides, proteins, glycosidic bonds, alcohol bonds, a plasticized starch, starches, blends of starches, or a combination thereof. The biodegradable polymers may include a low degree of polymerization or a low molecular weight so that microorganisms may break down the polymer. The biodegradable polymer may be present in an amount of about 10 percent or more, 20 percent or more, 30 percent or more, 40 percent or more, 50 percent or more, or even 60 percent or more of the total composition. The biodegradable polymer may be present in an amount of about 95 percent or less, about 90 percent or less, about 80 percent or less, about 70 percent or less, or about 60 percent or less of the total composition. The biodegradable polymer may be in communication with or include fillers. The biodegradeable polymer may act as a glue that holds a device together including the fillers or fibers.

The plant-based fillers may function to provide strength, reduce cost, prevent failures in a length-direction, prevent failures in a radial direction, prevent crushing, prevent flexure failures, or a combination thereof. The plant-based fillers may be made from or include a single type of plant. The plant-based filler may be or include cellulose, hemi-cellulose, lignin, bast, hurd, or a combination thereof. The plant-based filler may be formed by mechanically grinding a plant, chemically decomposing all or a portion of a plant, or a combination of both. For example, the plant may be mechanically ground and then the plant may be subjected to a chemical process where components of the plant are removed (e.g., the lignin and/or waxes). The plant-based filler is free of color. The plant-based filler may have dimensions (e.g., length and cross-sectional thickness).

A length of the plant-based filler may be a largest dimension of the plant based filler. The length of the plant-based filler is generally in a direction of growth of the plant (e.g., a fiber length). The length of the plant-based filler may be substantially perpendicular to a cross-sectional length. The cross-sectional length may be a diameter. The cross-sectional length may have a major length and a minor length (e.g., if the filler is oval). The dimensions of the plant-based filler may be reduced during processing such that the plant-based filler is particles, cubes, cylinders, has a length equal to a cross-sectional length, or a combination thereof. The length, cross-sectional, length, or both may be partially or fully covered by the biodegradable polymer. The dimensions of the plant-based filler may be reduced until the plant-based filler goes from a fiber to a particle. The plant-based filler may be classified after the plant-based filler is reduced in size (e.g., refined, ground, mechanically changed, chemically changed, or a combination thereof).

The classification may be performed based on a major dimension of the plant-based particles whether the major dimension is a length, a cross-sectional length, a diagonal direction, or a combination thereof. The classification may be one or more screens that remove any fillers over a predetermined size. The predetermined size may depend on the device being formed such that a thicker wall device may include larger particles than a thinner walled device. The classification may classify the particles so that a size distribution (e.g., average size distribution) is from about 5 microns to about 30 microns. The particles may have an average size of about 1 micron or more, about 5 microns or more, about 10 microns or more, about 15 microns or more, about 20 microns or more, or about 25 microns or more. The particles may have an average size of about 50 microns or less, about 45 microns or less, about 40 microns or less, about 35 microns or less, or about 30 microns or less. The plant-based filler may be made of virtually any plant.

The plant-based filler may be made of a combination of plants. The plant-based filler may be made of a single plant type. The plant-based filler may be made of a virgin material, a recycled material, a waste byproduct, a pre-processed material, or a combination thereof. The plant-based filler may be hemp, corn, cotton, soybeans, sugarcane, straw, woodchips, sawdust, hops, or a combination thereof. The plant-based filler may be made entirely of hemp or a portion of hemp. For example, the plant-based filler may include the bast of the hemp and the hurd of the hemp. The plant-based filler may be present in the composition, the device, or both in an amount of about 5 percent or more, about 10 percent or more, about 15 percent or more, about 20 percent or more, about 25 percent or more, about 30 percent or more, or about 35 percent or more by a total weight of the composition, the device, or both. The plant-based filler may be present in the composition, the device, or both in an amount of about 50 percent or less, about 45 percent or less, or about 40 percent or less by a total weight of the composition, the device, or both. The plant-based filler may be placed within the composition before the composition is mixed, extruded, or both.

The plant-based filler may be added to the composition before mixing so that the plant-based filler is substantially evenly distributed throughout the composition, the device, or both. The composition may uniformly have plant-based filler therein. The composition may be homogenous relative to all of the components, the plant-based filler, or both. The plant-based filler during extrusion may have a same orientation pre-extrusion and post-extrusion. The extrusion process may not change the orientation of the filler within the composition and/or device. The orientation of the plant-based filler may be generally random. The randomness may be that 50 percent of less, about 40 percent or less, or 35 percent or less of the plant-based filler are orientation in a same direction. For example, some of the plant-based fillers may be oriented in a direction of extrusion, some of the fillers may be oriented perpendicular to the direction of extrusion, and some of the fillers may be oriented there between. The plant-based filler may increase a tensile strength, an impact strength, or both relative to neat polymer only. The polymer may have a tensile strength, an impact strength, or both of X′ and the polymer with filler may have a tensile strength, an impact strength, or both of about 1.2X′ or more, about 1.5X′ or more, about 2X′ or more, about 2.5X′ or more, or about 3X′ or more. The plant-based filler may be free of being combined with a compatibilizer.

The compatibilizer may function to increase melt strength of the composition when the composition is in molten form, increase bonding between the biodegradable polymer and the plant-based filler, or both. A single compatibilizer may be in the composition. Two or more compatibilizers may be in the composition. The one or more compatibilizers may be introduced into the composition at one or more times.

A first compatibilizer may be introduced into the composition at a first period of time. The first compatibilizer may be introduced in a batch or continuously. The first compatibilizer may change a melt strength of the composition. For example, the composition may have a melt strength of x with none of the first compatibilizer. When the first compatibilizer is added the melt strength may be about 1.2× or more, about 1.5× or more, about 1.75× or more, about 2× or more, about 2.5× or more, or about 3× or more. The first compatibilizer may increase the melt strength about 10× or less or about 5× or less. The first compatibilizer may be or include poly(vinyl acetate), poly(ethylene vinyl acetate) copolymers, acetate copolymer, ethylene oxide, propylene oxide, or acrylic based copolymers. The first compatibilizer may be present in an amount of about 1 percent or more, about 2 percent or more, about 3 percent or more, about 5 percent or more, about 7 percent or more, or about 10 percent or more (e.g., ±0.5 percent or ±1 percent). The first compatibilizer may be present in an amount of about 25 percent or less, about 20 percent or less, about 18 percent or less, or about 15 percent or less. The first compatibilizer and the second compatibilizer may have a same chemical composition or a different chemical composition. For example, the first compatibilizer may be provided in a first amount and the second compatibilizer may be provided in a second amount that different than the first amount such that the first compatibilizer and the second compatibilizer are different.

The second compatibilizer may be introduced into the composition at a second period of time. The second compatibilizer may be introduced in a batch or continuously. The second compatibilizer may assist in increasing a bond strength between the filler and the biocompatible polymer. For example, the biocompatible polymer and the filler may have a bond strength of about Z when the second compatibilizer is not present. When the second compatibilizer is added the bond strength between the polymer and the filler may be about 1.5Z or more, about 2Z or more, about 2.5Z or more, or about 3Z or more. When the second compatibilizer is added the bond strength between the polymer and the filler may be about 10Z or less, 7.5Z or less, or about 5Z or less. The second compatibilizer may be or include a biodegradable polyester, a poly acrylic acid, a functionalized biodegradable polyester (e.g. bonded with maleic anhydride). The second compatibilizer may be present in an amount of about 1 percent or more, about 2 percent or more, about 3 percent or more, about 5 percent or more, about 7 percent or more, or about 10 percent or more (e.g., ±0.5 percent or ±1 percent). The second compatibilizer may be present in an amount of about 25 percent or less, about 20 percent or less, about 18 percent or less, or about 15 percent or less. In addition to the second compatibilizer, the composition may include one or more lubricants.

The lubricants may function to change a viscosity of the composition, assist the filler in moving within the composition, assist the composition in moving through a device of manufacture (e.g., an extruder), or a combination thereof. The lubricant may have a low molecular weight (e.g., 1,500 or less). The molecular weight may be about 1,000 or more, about 1,200 or more, about 1,500 or more, or about 2,000 or more. The lubricant may have a molecular weight of about 5,000 or less, about 3,500 or less, about 2,000 or less, or about 1,500 or less. The lubricant may have a viscosity of about 25 mPa-s or more, about 30 mPa-s or more, about 35 mPa-s or more, about 40 mPa-s or more, or about 45 mPa-s or more. The lubricant may have a viscosity of about 100 mPa-s or less, about 75 mPa-s or less, or about 60 mPa-s or less. The lubricant may be a food grade lubricant, a biodegradable lubricant, an oil, a grease, a plant-based oil, polyalkylene glycol, polyethylene oxide, polypropylene oxide, or a combination thereof. The lubricant may be free of water. The lubricant may be added to the composition in an amount of about 0.5 percent or more, about 1 percent more, or about 2.5 percent or more by total weight of the composition. The lubricant may be added to the composition in an amount of about 10 percent or less, about 7.5 percent or less, or about 5 percent or less by total weight of the composition. The lubricant may vary a viscosity within the composition so that during extrusion lower viscosity substances flow to the outside of the article of manufacture while higher viscosity items (e.g., plant based fillers) remain within an interior of the article of manufacture (e.g., a straw or the device discussed herein). The device may only include a lubricant. The lubricant may be used with a plasticizer or a plasticizer may be used in place of a lubricant.

The plasticizer may function as a lubricant. The plasticizer may cause portions of the composition to flow during manufacture. The plasticizer, the lubricant, or both may cause portions of the composition to flow when the composition is subjected to shear. The shear may cause low viscosity components of the composition to flow to an outside while higher viscosity portions remain on an insider such that the filler remains in a center of the device while the outer diameter and the inner diameter of the device are free of filler. The plasticizer, the lubricant, or both may assist in distributing the filler within the device.

The device and/or composition may include a filler (such as a plant-based fiber or particle, portions of the hemp plant, portions of the hurd of the hemp plant). The filler may modify a resultant device such that the filler assists the device to:—accelerates decomposition;—reduce the density thereby reducing the weight of the device;—reduce an amount of biodegradable polymer in the device; improve tensile and impact strength over the neat biodegradable polymer, or a combination thereof.

The composition once fully combined has a melt flow index. The melt flow index may be about 1 g/10 min to about 5 g/10 min at 190° C. grams/10 minutes. The melt flow index may be about 1 g/10 min or more, about 2 g/10 min or more, or about 5 g/10 min or more. The melt flow index may be about 50 g/10 min or less, about 40 g/10 min or less, about 30 g/10 min or less, about 20 g/10 min or less, about 10 g/10 min or less, or about 7 g/10 min or less.

The device of manufacture taught herein may be a utensil. The utensil may be a drinking straw. The device herein may be a drinking straw. Drinking straws and other thin-walled melt extruded tubing are produced by melting and mixing a suitable polymer compound on a single screw extruder and forcing the melt out through a die of defined geometry to form a molten polymer tube. The drinking straw may have a cross-sectional shape. The cross-sectional shape may e circular, oval regular, irregular, or a combination thereof. The tube is pulled through several inches of open space to a sizing die at the front of a water bath. Internal air pressure inside the tube forces the molten tube against the inner diameter of the sizing die to lock in the final diameter of the tube. The drawing action determines the wall thickness as the outer diameter is set by the sizing die. The tube transitions out of the sizing die into a water bath where it is quenched and solidified.

Thin-walled extruded tubing in general and drinking straws in particular have wall thicknesses between 0.1 and 0.22 mm

The addition of a small amount of plasticizer or lubricant (list family) that is only mildly miscible with the primary polymer may cause the biodegradable polymer to migrate to the outer surfaces and drive the filler into the center of the extrudate wall, helping to avoid blow outs at high solids loadings.

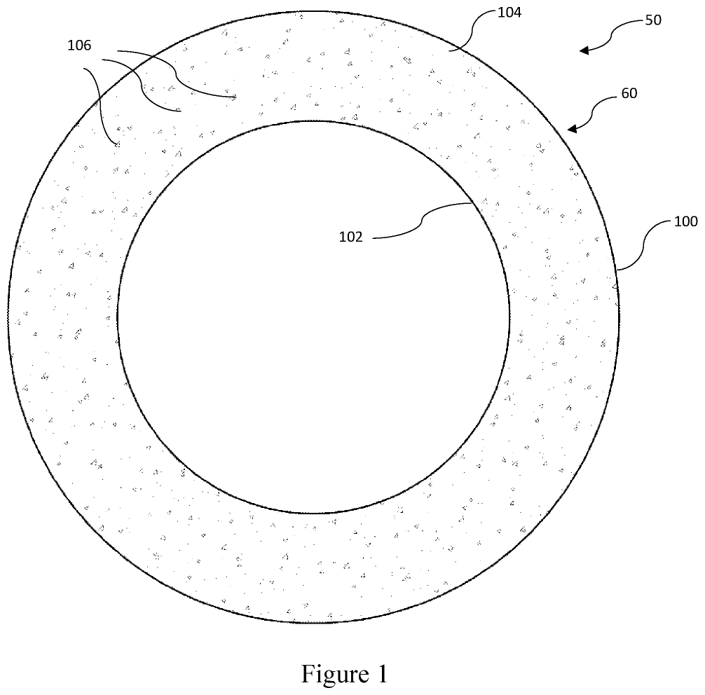

FIG. 1 illustrates a cross sectional view of a utensil 50. The utensil 50 as depicted is a straw 60 having an outer wall 100 and an inner wall 102. A polymer 104 and filler particles 106 are located between the outer wall 100 and the inner wall 102. As shown, the filler particles 106 are randomly spaced within the polymer 104.

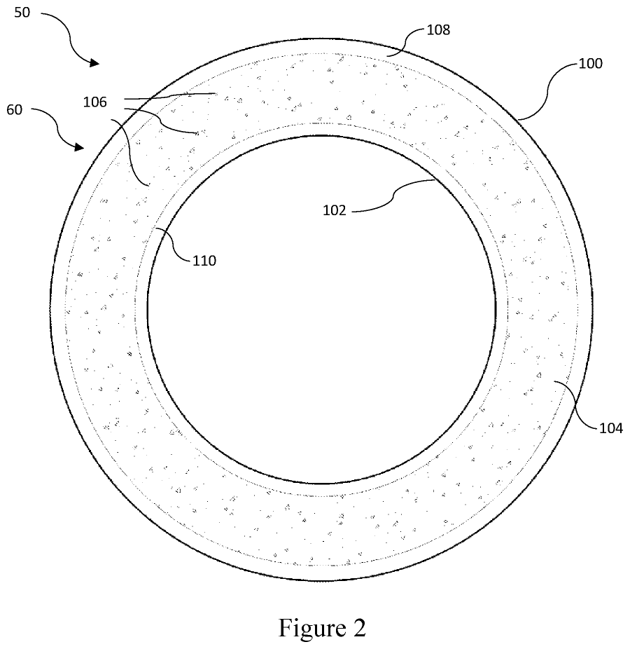

FIG. 2 illustrates a cross-sectional view of a utensil 50 depicted as a straw 60. The utensil 50 includes an outer wall 100 and an inner wall 102. An outer boundary layer 108 is formed at the outer wall 100 and an inner boundary layer 110 is formed at the inner wall 102. The outer boundary layer 108 and the inner boundary layer 110 are made only of polymer 104. Between the outer boundary layer 108 and the inner boundary layer 110 the utensil includes both the polymer 104 and filler particles 106. The filler particles 106 may be randomly located within the polymer 104.

### Example

In one example, the composition taught herein is combined together to form a utensil such as a straw. The components of the composition are added into a co-rotating, intermeshing twin screw extruder with a 27 mm diameter screws and a total length of 52 diameters or approximately 1.4 meters was used to prepare blends of a biopolymer and hemp. The twin screw compounding line consisted of 13 barrel sections, each 4 L/D. The first barrel section was a feed port into which the base polymer and the compatibilizer were fed.

The hemp was introduced via a twin screw side stuffer feeder which was supplied hemp by a loss in weight feeder. The feed port for the hemp was barrel section 5. Barrel section 4, is upstream of the hemp feed and was an open vent to allow degassing of any entrained air that would come in with the hemp.

Barrel section 7 is a devolatilizing vent which was run under atmospheric pressure and barrel section 10 was a devolatilizing vent which was run under full vacuum. Barrel section 12 was used for the addition of the plasticizer/lubricant which were introduced as a liquid feed via a gear pump to ensure consistent flow to the extruder. The gear pump was fed from a heated tank which contained the plasticizer. The formulation of the composition is presented in Table I below, and zone temperature settings are listed in Table II below.

TABLE 1

| | | Weight Pct |
|---|---|---|
| Component | Component type and grade | (%) |
| Primary Resin | Polybutylene succinate | 45.00% |
| | (MFI 2 grams/10 min @ 190 C.) | |
| Compatibilizer | ethylene vinyl acetate copolymer | 12.00% |
| Plant Based Filler | hemp (20-60 micron particle size) | 40.00% |
| Lubricant/Plasticizer | citric acid ester | 3.00% |

The hemp was derived from the hurd or the core of the hemp stalk and processed to a particle size distribution of 20-60 micron particle size. The hemp was dried to 2% moisture content.

The line was run at 50 lbs/hr output, a screw speed of 350 rpm, and the product was stranded through a four-hole stranding die. The strands were air-cooled to minimize exposure to moisture before being pelletized in a strand pelletizer.

The product was packed out in sealed polyethylene bags to prevent moisture pick up.

TABLE 2

| Extruder Zone | Setting |
|---|---|
| Zone 1 (feed) | 150° C. |
| Zone 2 | 150° C. |
| Zone 3 | 150° C. |
| Zone 4 (atm vent) | 150° C. |
| Zone 5 hemp feed | 150° C. |
| Zone 6 | 150° C. |
| Zone 7 (vac vent) | 130° C. |
| Zone 8 | 130° C. |
| Zone 9 | 130° C. |
| Zone 10 | 130° C. |
| Zone 11 | 130° C. |
| Zone 12 | 130° C. |
| Zone 13 | 130° C. |
| Zone 14 die | 160° C. |

The compound was subsequently used to extrude drinking straws on a single screw extruder consisting of a screw diameter of 55 mm and a length of 24:1 L/D or 1.32 meters. The product was extruded through a die of 20 mm in diameter and over a mandrel of 16 mm. The extruded tube was then fed to a vacuum tank fitted with a sizing die of 19 mm. The extruder was run at a screw speed of 36 rpm and had barrel temperatures set at:

| | |
|---|---|
| Zone 1 | 210 C. |
| Zone 2 | 200 C. |
| Zone 3 | 190 C. |
| Zone 4 | 190 C. |
| Die | 190 C. |

The extrudate from the vacuum tank was cut in an automatic cutter to produce straws with an outer diameter of 19 mm with an average wall thickness of 0.15 mm.

Examination of the produced straws reveals a layer that is relatively filler-free on the outside surface that is approximately 0.005 mm thick and a layer on the inside of the straw that is approximately 0.003 mm thick relatively free of filler.

We claim:

1. A composition comprising:
a biodegradable resin;
a plant-based filler present in an amount of about 20 percent or more based on a total weight of the composition;
one or more compatibilizers; and
a plasticizer, a lubricant, or both;
wherein the composition is configured to be extruded so that the composition forms a wall having a thickness from about 0.1 mm to 0.22 mm.

2. The composition of claim 1, wherein the composition includes a biodegradable resin and a lubricant.

3. The composition of claim 2, wherein the lubricant is present in an amount of about 1 percent to about 5 percent based on a total weight of the composition.

4. The composition of claim 1, wherein the compatibilizer includes or is an ethylene vinyl acetate copolymer.

5. The composition of claim 1, wherein the plant-based filler is hemp.

6. The composition of claim 1, wherein the plant-based filler is present in an amount of about 40 percent or less based on a total weight of the composition.

7. The composition of claim 1, wherein the plant-based filler has an average size of about 5 microns to about 30 microns.

8. The composition of claim 1, wherein the composition has a melt flow index of about 1 g/10 min to about 5 g/10 min at 190° C. grams/10 minutes.

9. The composition of claim 1, wherein the biodegradable polymer is derived from starch or a starch blend.

10. A device comprising:
a wall having a thickness from about 0.1 mm to about 0.22 mm;
a biodegradable polymer;
a plant-based filler;
one or more compatibilizers; and
a plasticizer, a lubricant, or both;
wherein the plant-based filler is present in an amount from about 20 percent to about 40 percent by weight of the device; and
wherein the wall has an inner side and an outer side with a middle located therebetween.

11. The device of claim 10, wherein the plant-based filler is only located within the middle and the plant-based fillers are free of extension through or to an exterior of the wall.

12. The device of claim 10, wherein substantially all of the plant-based filler is located within the middle.

13. The device of claim 10, wherein 70 percent or more of the plant-based filler is located within the middle.

14. The device of claim 10, wherein the plant-based filler is randomly oriented within the device.

15. The device of claim 10, wherein the lubricant is present in an amount of about 1 percent to about 5 percent based on a total weight of the composition.

16. The device of claim 10, wherein the compatibilizer includes or is an ethylene vinyl acetate copolymer.

17. The device of claim 10, wherein the plant-based filler is hemp and the biodegradable polymer is derived from starch or a starch blend.

18. The device of claim 10, wherein the device is biodegradable from about 4 weeks to about 1 year when the device is contacted with water.

19. The device of claim 10, wherein the device includes one or more boundary layers that form an external wall of the device and the one or more boundary layers are substantially free of filler.

20. The device of claim 10, wherein the device includes one or more boundary layers that form an external wall of the device and the one or more boundary layers are substantially only biodegradable polymer.
